(19) United States
(12) Patent Application Publication
(10) Pub. No.: US 2017/0191838 A1
(43) Pub. Date: Jul. 6, 2017

(54) AUTOMATED VEHICLE ROUTE SELECTION BASED ON OCCUPANT INTEREST

(71) Applicant: DELPHI TECHNOLOGIES, INC., TROY, MI (US)

(72) Inventors: Michael H. Laur, Mission Viejo, CA (US); Nandita Mangal, Palto Alto, CA (US); Anthony Nguyen, Fremont, CA (US)

(21) Appl. No.: 14/987,230

(22) Filed: Jan. 4, 2016

(51) Int. Cl. G01C 21/34; G05D 1/00

(52) U.S. Cl. CPC G01C 21/34; G05D 1/0088

(57) ABSTRACT

A navigation system suitable to use on an automated vehicle includes an occupant-detection device and a memory. The occupant-detection device is used to determine a degree-of-interest of an occupant of a vehicle. The degree-of-interest is determined with regard to a route traveled by the vehicle. The memory used to store an interest-score of the route. The interest-score is based on the degree-of-interest exhibited by the occupant while traveling the route. The system may include a controller. The controller is in communication with the occupant-detection device and the memory. The controller is configured to operate the vehicle. The controller selects a preferred-route from a plurality of possible-routes. The preferred-route is characterized by a maximum-value of a prior-score associated with each one of the plurality of possible-routes.

### TECHNICAL FIELD OF INVENTION

This disclosure generally relates to a navigation system suitable to use on an automated vehicle, and more particularly relates to a system or controller that selects a route based on an interest-score associated with the route.

### BACKGROUND OF INVENTION

Route planners or navigation systems that select a route based on shortest distance or briefest time are known. However, sometimes multiple routes are suitable to travel to destination, and an occupant of an automated vehicle may be bored by the route with shortest distance or briefest time.

### SUMMARY OF THE INVENTION

In accordance with one embodiment, a navigation system suitable to use on an automated vehicle is provided. The system includes an occupant-detection device and a memory. The occupant-detection device is used to determine a degree-of-interest of an occupant of a vehicle. The degree-of-interest is determined with regard to a route traveled by the vehicle. The memory used to store an interest-score of the route. The interest-score is based on the degree-of-interest exhibited by the occupant while traveling the route.

In another embodiment, the system includes a controller. The controller is in communication with the occupant-detection device and the memory. The controller is configured to operate the vehicle. The controller selects a preferred-route from a plurality of possible-routes. The preferred-route is characterized by a maximum-value of a prior-score associated with each one of the plurality of possible-routes.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a navigation system in accordance with one embodiment; and

FIG. 2 is an image processed by the navigation system of FIG. 1 in accordance with one embodiment.

### DETAILED DESCRIPTION

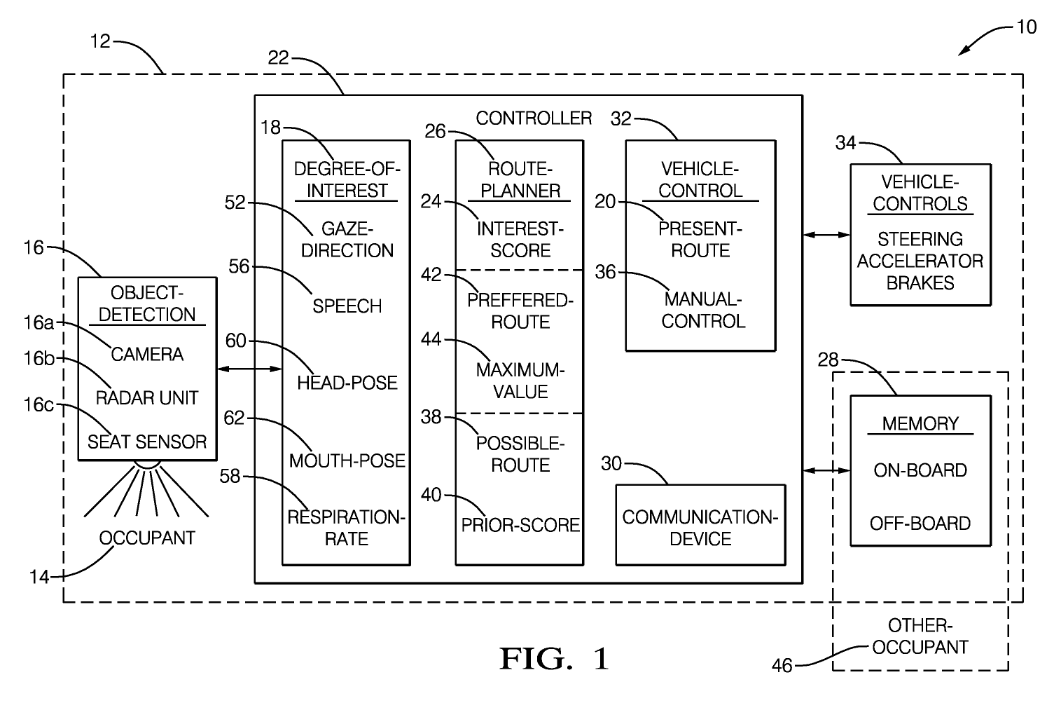

FIG. 1 illustrates a non-limiting example of a navigation system 10, hereafter referred to as the system 10, which is suitable to use on an automated vehicle 12, hereafter referred to as the vehicle 12. While the description presented herein is generally directed to a fully automated or autonomous vehicle where an occupant 14 is generally not directly involved with controlling the steering, acceleration, and braking of the vehicle 12, it is contemplated that the teachings presented herein are useful for vehicles with varying degrees of automation, including manually driven vehicles where the navigation system merely provides route guidance information to an operator of the vehicle.

The system 10 includes an occupant-detection device 16, hereafter the device 16, which is used to determine a degree-of-interest 18 of the occupant 14 of the vehicle 12. The device 16 may include any one or combination of, but is not limited to, a camera 16A, a microphone 16B, a seat sensor 16C, and/or a biometric-sensor (not show) such as a wearable biometric-sensor operable to monitor, for example, a heart-rate or pulse of the occupant 14. The process by which these particular examples of the device 16 could be used to determine the degree-of-interest 18 of the occupant 14 will be described in more detail later.

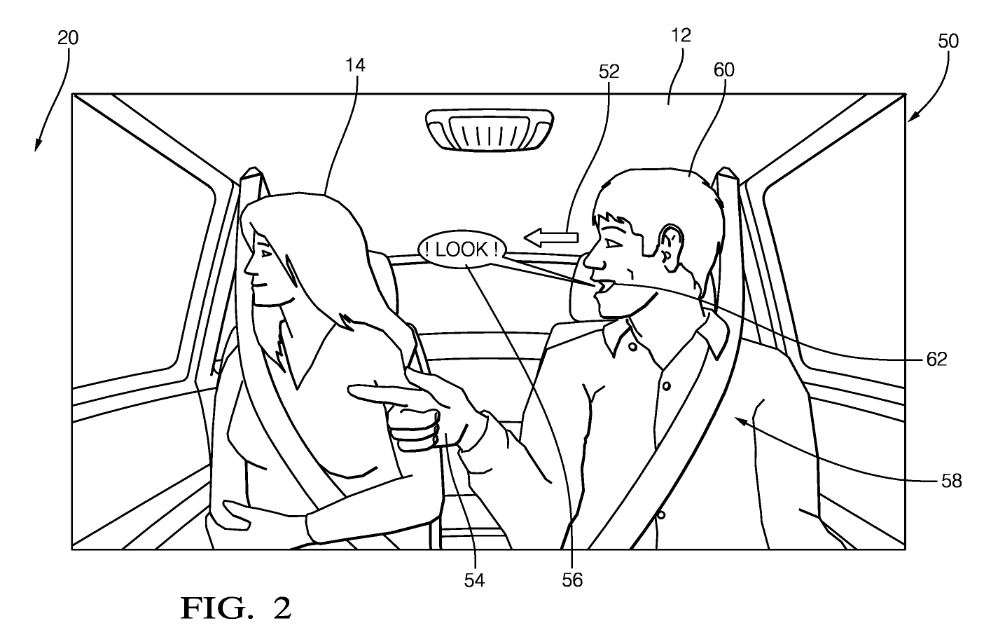

In general, the degree-of-interest 18 is determined with regard to a route 20 (FIG. 2) traveled by the vehicle 12. As used herein, the route 20 generally refers to the roadway or surface that the vehicle 12 travels upon, and any landscape-features/buildings/objects/persons present in the area surrounding of the roadway that are observable by the occupant 14. The degree-of-interest 18 is a general measure of how interesting the occupant 14 finds any particular landscape-features/buildings/objects/persons. For example, the degree-of-interest 18 could be influenced by the occupant 14 observing a restaurant or retail-store proximate to the vehicle 12, or an interesting view of landscape viewable from the vehicle 12. It is contemplated that the system 10 may also be useful in ‘closed’ environments such as a mining operation where the degree-of-interest 18 could be used to influence the control of an autonomous mining truck where certain points of interest (good or bad) are catching the attention of an operator, i.e. the occupant 14.

The system 10 may include a controller 22 configured to determine an interest-score 24 based on the degree-of-interest 18 exhibited by the occupant 14 while traveling the route 20. The controller 22 may include a processor (not specifically shown) such as a microprocessor or other control circuitry such as analog and/or digital control circuitry including an application specific integrated circuit (ASIC) for processing data, as should be evident to those in the art. The controller 22 is generally configured to execute one or more routines to, for example, determine the degree-of-interest 18, the interest-score 24, and/or operate a route-planner 26 to select the route 20.

The system 10 may include a memory 28, including non-volatile memory, such as electrically erasable programmable read-only memory (EEPROM) to store the interest-score 24 of the route 20. The memory 28 may include on-board memory installed in the vehicle 12, and/or may include off-board memory, i.e. storage ‘in-the-cloud’ memory, or a combination thereof. That is, the memory 28 may be directly accessible by the controller because it is on-board memory, or the memory 28 may be remotely accessible via a communication-device 30 such as a wireless transceiver, or the memory 28 may be combination of on-board and off-board memory where the communication device 30 is used to update the on-board memory with information accumulated by the off-board memory.

Continuing to refer to FIG. 1, the controller 22 is shown as being in communication with the device 16 and the memory 28. The controller 22 may also include a vehicle-control 32 configured to operate the vehicle 12 via communications with vehicle-controls 34 operable to control any one or combination of the vehicle's steering, accelerator, and/or brakes. The vehicle-control 32 may provide for fully automated operation of the vehicle 12 to follow the present-route (i.e. the route 20), or may allow for manual-control 36 of the vehicle 12 where the occupant 14 controls the steering, acceleration, and braking of the vehicle 12.

When the occupant 14 selects or enters a new destination, the route-planner 26 generates a plurality of possible-routes 38 to the destination. The number of possible-route may be limited to those that fit some predetermined limitations which may be defined by either the occupant 14 and/or the route-planner 26. For example, the route-planner 26 may limit the possible-routes 38 to those with a travel-time less than twenty-five percent (25%) greater than the briefest possible travel-time. For each of the possible-routes 38 the route-planner 26 determines a route-score based on a prior-score 40 of each of the possible-routes 38. The prior-score 40 may be based on degrees-of-interest of other persons who previously traveled all of part of the possible-routes, or may be based, at least initially, on a rating given for the route by a digital mapping service.

The route-score may be based on a single value of the prior-score 40, or may be based on a combination of prior-scores for each of multiple trip-segments that are combined or connected together to form an instance of the possible-routes 38. It is contemplated that some of the possible-routes 38 may include some of the same trip-segments when no alternatives are available, e.g. when there is only one option for some of the trip-segments that are used to determine the possible-routes 38. For example, there may be many possible-routes through a city, but only one option to travel across a mountain range that meet the above mentioned time limitations. Once the route-scores for all of the possible-routes 38 are calculated, the controller 22 selects a preferred-route 42 from the plurality of possible-routes 38, where the preferred-route 42 characterized by a maximum-value 44 of the prior-score 40 (or combination of prior-scores) associated with each one of the plurality of possible-routes 38.

As suggested above, the prior-score 40 may be determined based on the degree-of-interest 18 exhibited by an other-occupant 46 during a prior instance of traveling the route 20 or a segment of the route 20 used to determine the route-score for each of the possible-routes 38. By way of further example and not limitation, if the vehicle 12 is an automated-taxi, the other-occupant 46 may have previously been a passenger of the taxi, i.e. the same vehicle. Alternatively, the other-occupant 46 may be the owner of another vehicle (not shown, but equipped similar to the vehicle 12) who previously traveled the route and the degree-of-interested exhibited by the other-occupant 46 was registered with the memory 28 so the prior-score 40 can be determined.

It is contemplated that the interest-score 24 of the occupant 14, and/or the degree-of-interest exhibited by the other-occupant 46 can be used to regularly update the prior-score. That is, the prior-score 40 is updated to incorporate the interest-score 24. It is recognized that if the occupant 14 and/or the other-occupant 46 travels the preferred-route 42 frequently, almost every weekday while traveling to work for example, the occupant 14 and/or the other-occupant the degree-of-interest 18 may decrease over time because of familiarity. As such, the influence on the prior-score 40 may diminish overtime for the same occupant repeatedly traveling the same preferred-route 42.

FIG. 2 illustrates a non-limiting example of an image 50 captured or taken by the camera 16A showing the occupant 14 (e.g. an operator on the right and a passenger on the left of the image 50) while traveling the route 20 in the vehicle 12. The controller 22 may process the image 50 using known techniques to determine a gaze-direction 52 indicated by the eyes of the occupant and/or a gesture 54 of the occupant 14. The controller 22 then determines the degree-of-interest 18 based on these indicators. In this example the gaze-direction 52 and gesture 54 indicate that something is of interest outside of the vehicle, so the degree-of-interest 18 would be increased relative to a situation when, for example, the occupant 14 was looking down at a personal-electronics-device such as a tablet or a smart-phone.

By way of further example, the microphone 16B may be used to detect speech 56 spoken or uttered by the occupant 14. If a word such as “look” is spoken, the controller 22 would increase the degree-of-interest 18 relative to a situation when the occupant did not speak. The controller 22 may be further configured to determine the context of the speech. For example, the occupant may further say, for example, “That is my favorite restaurant.” The controller 22 may consult navigation information, which may or may not be combined with head pose, eye gaze, or gesture information captured by camera 16A to determine which restaurant is the occupant's favorite and post a ‘like’ on social media.

By way of further example, the camera 16A may be configured to detect infrared light and so be able to detect fluctuations in temperature about the mouth and/or nose of the occupant 14 and thereby determine a respiration-rate 58 of the occupant 14. If a sudden increase in the respiration-rate 58 is detected, that may be used an indication that the degree-of-interest 18 of the occupant 14 has increased. By way of further example, the camera 16A may be further used by the controller 22 to determine a head-pose 60 and/or a mouth-pose 62. If the head-pose 60 is looking forward or down, that may be an indication that the occupant is not particularly interested in what is present outside of the vehicle 12. If the mouth-pose 62 corresponds to a shocked or surprised facial expression by the occupant 14, then that may be an indication that the occupant is very interested in what is present outside of the vehicle 12.

The seat sensor 16C may be what is used to determine occupant seating position and/or weight and/or presence for controlling air-bag deployment in the event of a collision. For example, if the seat is reclined, then that may be an indication that the occupant is not particularly interested in what is present outside of the vehicle 12, so the degree of interest-of-interest 18 is decreased. By contrast, if the seat sensor 16C indicates that the occupant 14 is turned away from a centered orientation and/or leaning toward a window, then that be an indication that the occupant 14 is very interested in what is present outside of the vehicle 12, so the degree of interest-of-interest 18 is increased.

Accordingly, a navigation system (the system 10) suitable to use on an automated vehicle and a controller 22 for the system 10 is provided. The degree-of-interest 18 and/or the interest-score 24 can be used to update the prior-score 40 stored in the memory 28 so the prior-score 40 becomes an indicator of the degree-of-interest exhibited by many people, i.e. representative of the result of a poll. Such information may be particularly appreciated by a visitor from out-of-town who hires or rents an automated taxi for transportation to some particular destination, or to simply take a tour of the area.

By way of further example, the previously mentioned biometric-sensor may be configured to detect the respiration-rate 58 and/or the heart-rate so be able to detect fluctuations in the respiration-rate 58 and/or the heart-rate of the occupant 14. If a sudden increase in the respiration-rate 58 or the heart-rate is detected, that change may be used as an indication that the degree-of-interest 18 of the occupant 14 has increased.

While this invention has been described in terms of the preferred embodiments thereof, it is not intended to be so limited, but rather only to the extent set forth in the claims that follow.

We claim:

1. A navigation system suitable to use on an automated vehicle, said system comprising:
an occupant-detection device used to determine a degree-of-interest of an occupant of a vehicle, said degree-of-interest determined with regard to a route traveled by the vehicle; and
a memory used to store an interest-score of the route, said interest-score based on the degree-of-interest exhibited by the occupant while traveling the route.

2. The system in accordance with claim 1, wherein the system includes
a controller in communication with the occupant-detection device and the memory and configured to operate the vehicle, wherein the controller selects a preferred-route from a plurality of possible-routes, said preferred-route characterized by a maximum-value of a prior-score associated with each one of the plurality of possible-routes.

3. The system in accordance with claim 2, wherein the prior-score is determined based on the degree-of-interest exhibited by an other-occupant during a prior instance of traveling the route.

4. The system in accordance with claim 2, wherein the prior-score is updated to incorporate the interest-score.

5. The system in accordance with claim 1, wherein the memory is not located at the vehicle, and the system includes a communication-device operable by the controller to communicate with the memory.

6. The system in accordance with claim 1, wherein the occupant-detection device is used to determine the degree-of-interest based on one or more of a gaze-direction of the occupant, gesture by the occupant, speech uttered by the occupant, a respiration-rate of the occupant, a heart-rate of the occupant, a head-pose of the occupant, and a mouth-pose of the occupant.
